(19) United States
(12) Patent Application Publication
(10) Pub. No.: US 2019/0065605 A1
(43) Pub. Date: Feb. 28, 2019

(54) CODE-BASED SEARCH SERVICES

(71) Applicant: T-Mobile USA, Inc., Bellevue, WA (US)

(72) Inventor: Vinod Ravichandran, Renton, WA (US)

(21) Appl. No.: 15/687,803

(22) Filed: Aug. 28, 2017

(51) Int. Cl. G06F 17/30; H04M 1/725; H04M 3/493; G10L 15/22

(52) U.S. Cl. CPC G06F 17/30867; H04M 1/72561; H04W 84/042; G10L 15/22; G06F 17/30991; H04M 3/4938

(57) ABSTRACT

A code-based search service is described herein. A user transmits a code to a carrier core network, connecting the mobile device to a search service. The search service analyzes the code to determine a search string and transmits the search string to a search engine. The search results are transmitted to the mobile device using an interactive voice response system, whereby a user can interact with the search service using the interactive voice response system.

### BACKGROUND

Finding services using conventional search systems often require the use of a website as an interface between a search inquiry and a search service. For example, a user desiring the location of a pizza restaurant will access a website having a search function. The user will input the search terms and receive results from the website using the website's search engine. The user selects one or more links to determine additional information about the results.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment.

FIG. 2 illustrates a search user interface.

FIG. 3 illustrates an example search process.

FIG. 4 illustrates a component level view of a mobile device configured to function within a wireless communication network.

FIG. 5 illustrates a component level view of a server configured for use within a wireless communication network in order to provide various services within the wireless communication network, such as the code-based search service.

### DETAILED DESCRIPTION

Described herein are technologies for code-based search services. In some examples, a system provides one or more search services. When a user using a mobile device, such as a cellular device, enters a code indicating the type of search service to be used, the system interfaces with a search service, retrieves information relevant to the code, and then provides the results using an interface service such as an interactive voice response service.

In some examples, using a code can achieve various technical benefits. In some examples, using a code can reduce the amount of bandwidth usage. In conventional search technologies, the Internet browser of a mobile device is used to search for and retrieve data relevant to a search request. However, along with the information about the search request, the data often includes other information such as HTML code to render the website within the browser, graphics, logos, and other data that may not be relevant to the search requested. This extraneous information increases the amount of data the cellular network carries and the amount of processing power required of the mobile device. The code-based system can provide a reduced set of information, thus preserving bandwidth for other use. These and other technical advantages can be achieved using various configurations of the presently disclosed subject matter.

While the technical details are presented herein in the general context of program modules, those skilled in the art will recognize that the configurations can also be implemented in combination with other program modules. Generally, program modules include routines, programs, components, data structures, and other types of structures that perform particular tasks or implement particular abstract data types.

Moreover, those skilled in the art will appreciate that the configurations described herein can be practiced with various computer system configurations, including hand-held devices, multiprocessor systems, microprocessor-based or programmable consumer electronics, minicomputers, mainframe computers, and the like. The configurations described herein can also be practiced in distributed computing environments where tasks are performed by remote processing devices that are linked through a communications network. In a distributed computing environment, program modules can be located in both local and remote memory storage devices.

In the following detailed description, references are made to the accompanying drawings that form a part hereof, and in which are shown by way of illustration specific configurations or examples. Referring now to the drawings, aspects of the various implementations provided herein and an exemplary operating environment will be described.

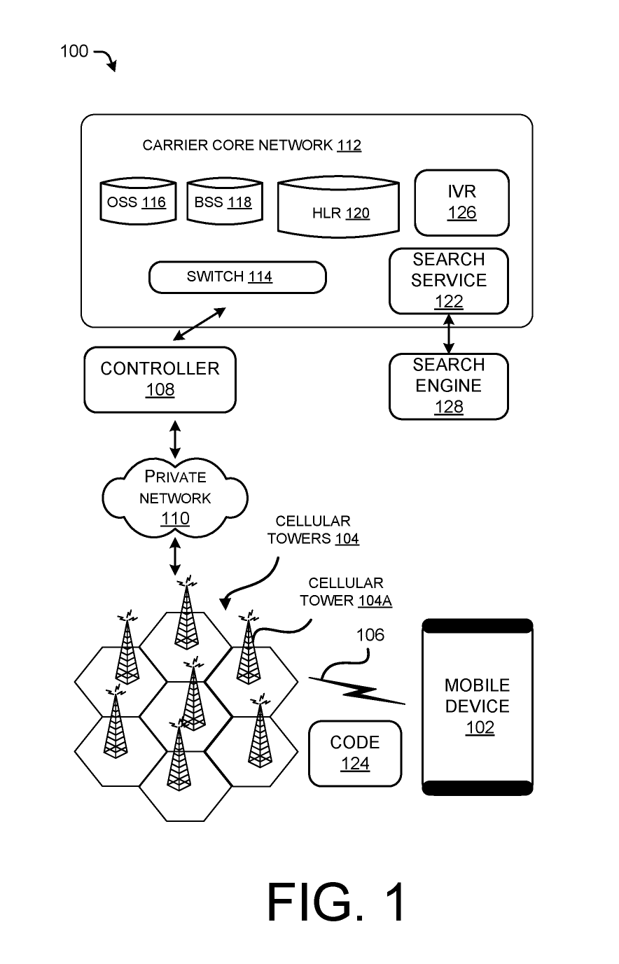

FIG. 1 illustrates an example network system 100 in which aspects of code-based search can be implemented within a cellular telephone-type network. Referring to FIG.1, the example network system 100 includes a cellular telephone network (such as a Global System for Mobile (GSM) network). In some examples, an IP network (not illustrated) may also be included or used, and is considered to be within the scope of the presently disclosed subject matter. The example network system 100 is in an Unlicensed Mobile Access (UMA)-type configuration that provides service to the user of a mobile device 102. Such service may include voice services, as well as, supplementary services like call forwarding and call waiting, text messaging services (e.g., SMS), and data-based services like ring tone downloads, game downloads, picture messaging, email, and web browsing.

In general, the described example network system 100 accepts registration requests and communication connections from the mobile device 102. To handle requests to the cellular telephone network, the cellular telephone network includes one or more cell towers 104 that are configured to accept cellular communications 106 from the mobile device 102. The cell towers 104 are connected to a base station controller 108 (such as a base station controller/radio network controller (BSC/RNC)) via a private network 110. The private network 110 can include a variety of connections (not shown) such as T1 lines, a wide area network (WAN), a local area network (LAN), various network switches, and other similar components.

The base station controller 108 controls communication traffic to a carrier core network 112, where all communications are managed (including both cellular and IP-based). Components of the carrier core network 112 in this example include a switch (e.g., a mobile switching center or MSC) 114, which is configured to control data/call flows and perform load balancing, as well as other functions. The carrier core network 112 may also include a variety of system databases such as an operation support subsystem (OSS) database 116, a business support system (BSS) database 118, and home location register (HLR) 120 or other central subscriber database that contains details of a carrier's subscribers for billing, call logging, and the like.

The carrier core network 112 also includes a search service 122. In some examples, the search service 122 is used by the carrier core network 112 to control and execute various functionality of a code-based search service. The search service 122 is invoked by the carrier core network 112 when a code 124 is received from the mobile device 102, indicating that a search is requested. The code 124 can be of various formats. For example, the code 124 can be a text code such as “#PIZZA”. The code 124 includes a term describing the particular subject matter to be searched. In this example, the subject matter is “Pizza.” A “#” or other symbol can be used to invoke the search service 122.

When the user enters the code 124 and causes the mobile device 102 to transmit the code 124 to the carrier core network 112, the carrier core network 112 recognizes the code 124 as a search service 122 requester. Instead of routing the code 124 in a manner similar to connecting the mobile device 102 to a receiving device such as another mobile device (not shown), the carrier core network 112 provides the code 124 to the search service 122, causing the search service 122 to be invoked. In some examples, a connection between the mobile device 102 and the search service 122 is made in a manner similar to connecting the mobile device 102 to another receiving device.

Once invoked, the search service 122 analyzes the code 124 to determine the type of search to be performed and, in some examples, the location of relevant results. With regard to the type of search, all or a portion of the code 124 is analyzed. In the current example in which the code 124 is #Pizza, the text “Pizza” is used to determine that the search is for pizza. In some examples, the code 124 can include other terms or symbols. In the current example, the symbol “#” is used by the carrier core network 112 to determine that the services of the search service 122 are requested. Other symbols, or search requester symbols, can be used and are considered to be within the scope of the presently disclosed subject matter.

The code 124 can use a singular phrase such as “Pizza” to indicate the type of search, or can include other information. In a different example, the code 124 can be “#Pizza@Seattle$”. In this example, the code 124 includes the search requester symbol “#” to invoke the search service 122. The code 124 in this example also includes the term “Pizza” to tell the search service 122 the type of search to conduct, i.e. pizza restaurant. However, unlike in the prior example, the code 124 includes additional information to narrow a field of the search results, as explained below.

In this example, the code 124 includes an “@” to indicate a location to where the search should be conducted (i.e. to indicate relevant results). In this example, the “@” symbol is followed by “Seattle,” indicating that the search requested is for the Seattle area. The code 124 further includes a “$” symbol to indicate a low-cost request. In this example, the “$” symbol indicates that relevant results are for pizza restaurants in the Seattle area having a relatively low cost. It should be noted that the presently disclosed subject matter is not limited to any particular type or use of symbols or texts.

In the current example, the code 124 includes “@Seattle” to indicate that the search should be conducted for pizza restaurants in the Seattle area. However, in some examples, the location of the mobile device 102 (or another device) can be used to narrow the list of search results. In some examples, the location of the mobile device 102 can be determined based on which of the cellular towers 104 the mobile device is communicating through or associated with. In some examples, the location of the mobile device 102 can be a latitude and longitude.

For example, the mobile device 102 may be associated with cellular tower 104A. The location of the cellular tower 104A is known, and thus, while the mobile device is associated with the cellular tower 104A, the location of the mobile device 102 is known. Other technologies for determining the location of the mobile device 102 can be used, such as global positioning system and WIFI, can be used and are within the scope of the presently disclosed subject matter.

The search service 122 can use the location of the mobile device 102 to search for results that are relevant to the location of the mobile device 102. For example, instead of using a code, such as “@Seattle” given in the example above, the search service 122 can use the location of the mobile device 102 to narrow the search results to pizza restaurants around the mobile device 102. The radius from the mobile device 102 that search results are considered relevant may vary. For example, the search service 122 may determine that search results for a pizza restaurant 5 miles from the location of the mobile device 102 are not relevant, and results for pizza restaurants less than 5 miles from the mobile device 102 are relevant.

Other than sending the search results as an audible prompt, in some examples, the search results can be rendered on a graphical interface of the mobile device. In other examples, the search results can be returned to a user using an interactive voice response (IVR) system 126. The IVR system 126 can allow the search service 122 to interact with the user through use of voice or tones input via a keypad on the mobile device 102. The IVR system 126 can present the results of the search to the user.

Using the example of #Pizza as the code 124, the IVR system 126 can present the results of the search as a series of options. For example, the IVR system 126 can present options to the user, such as “Press 1 for Pizza Pros,” “Press 2 for Pizza Express,” and so forth. Upon selection of a particular option, the carrier core network 112 can automatically connect the mobile device 102 to the selected provider or can provide the connection as a still further option, among other possibilities.

The search can be provided using various technologies. In FIG. 1, the search service 122 is in communication with a search engine 128. The search engine 128 can be an internet-based search engine or another form of engine. The presently disclosed subject matter is not limited to any particular type of engine. The search service 122 submits to the search engine 128 a search string based on information known to the search service 122. For example, if the code 124 is “#Car,” the search service 122 may have determined that the code 124 is a request for a rental car, so the term “rental car” can be part of the search string. Further, the search service 122 may include the location of the mobile device 102 as part of the search string transmitted to the search engine 128.

Continuing with the present example in which the code 124 is “#Pizza,” the search string transmitted to the search engine 128 can be “pizza restaurant east pike street and Minor avenue Seattle Washington.” The search service 122 receives the search results from the search engine 128, provides the search results to the IVR system 126 to present the search results to the user. It should be noted that the functionality of the search engine 128 can be provided by various resources, including the carrier core network 112 if so configured.

The presently disclosed subject matter does not require that the search engine 128 be a system external to the carrier core network 112. In some examples, the carrier core network 112 can include a data store of various services that may be the subject of searches. For example, the carrier core network 112 can have a data store containing a listing of pizza restaurants, the location of the pizza restaurants, the average cost to dine at the pizza restaurant, and the like. In this example, the search service 122 can access the data store and act as the search engine 128 rather than accessing an external search engine 128.

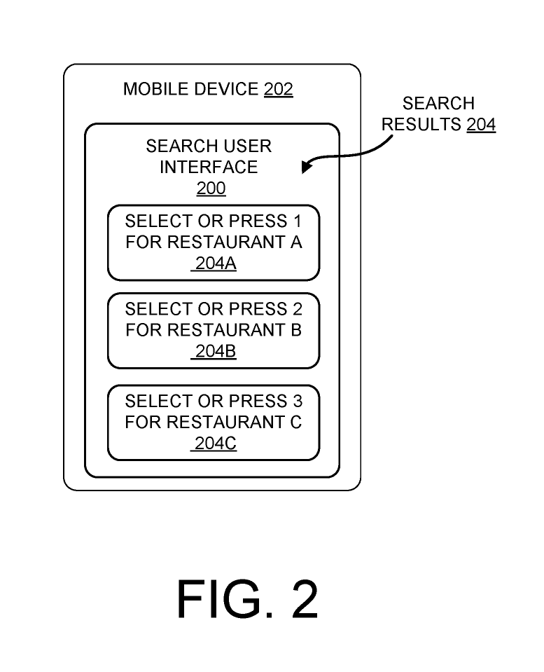

FIG. 2 is an illustration of an example search user interface 200 that may be used to perform code-based searching. As noted above, in one configuration, the user places a call to the search service 122 and results are returned audibly using the IVR system 126. In some configurations, it may be necessary for all or part of the code-based search technology to use visual aids rather than audible aids. For example, text may be required to allow the hearing impaired to search using codes.

In FIG. 2, a mobile device 202 has received search results 204 from the IVR system 126 and, rather than presenting the search results 204 audibly using the microphone of the mobile device 202, the search results 204 are rendered as text within the search user interface 200. In the search user interface 200, the individual search results 204 can be rendered to be merely information, or the individual search results 204 can be selectable interfaces. For example, the search result 204A can be configured to receive a finger or other input from a user as a means to indicate that the user wishes to select Restaurant A, or the user can press the number 2 on the keypad of the mobile device 202.

If a user selects one of the individual search results 204, the search service 122 can perform different functions depending on the particular configuration of the search service 122. As mentioned above, if one of the search results 204 is selected, information about the selected search result 204 can be presented to the user, either textually or audibly, or both. In other examples, if one of the search results 204 is selected, the carrier core network 112 may use information about the selected search result 204 to attempt to communicatively connect the mobile device 102 to the selected restaurant.

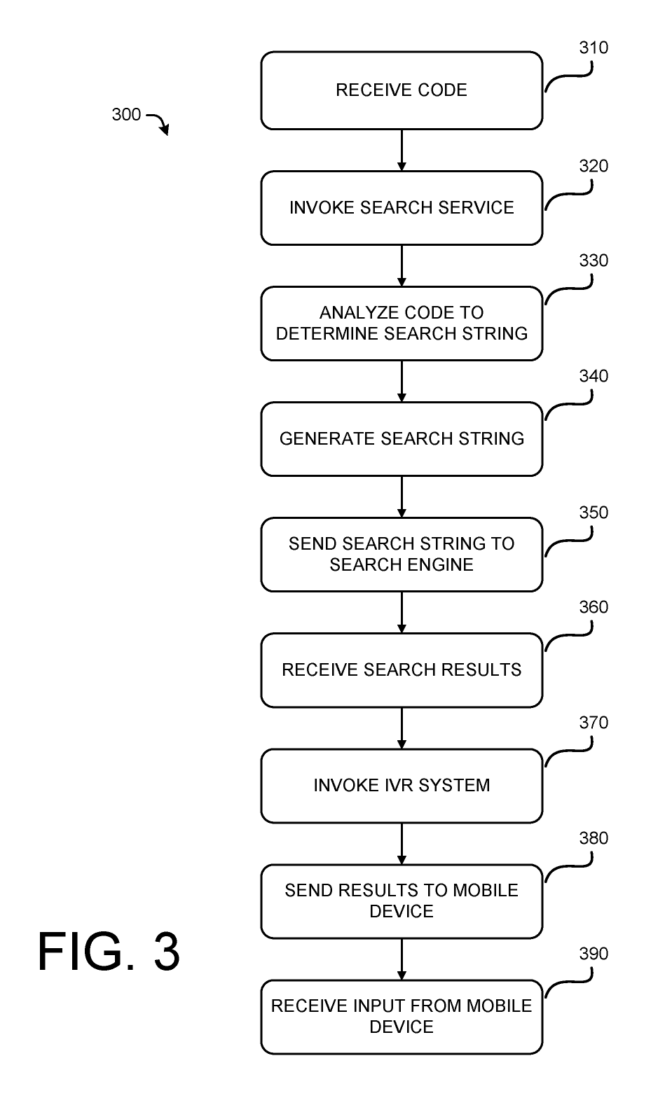

FIG. 3 illustrates an example code-based search process 300. The process is illustrated as example flow graphs, each operation of which may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Referring to FIG. 3, the code-based search process 300 commences at operation 310, where the code 124 is received at the search service 122. In some examples, the code 124 may invoke the cellular call function whereby the code is akin to a number that is dialed. The presently disclosed subject matter is not limited to any particular manner of connection between the search service 122 of the carrier core network 112 and the mobile device 102.

The code-based search process 300 continues at operation 320, where the search service 122 is invoked. The search service 122 is illustrated in FIG. 1 as being a function provided by the carrier core network 112. However, the presently disclosed subject matter is not limited in such a manner, as other configurations may be used. For example, the search service 122 may be a service external to the carrier core network 112 that the carrier core network 112 communicatively connects to when the code 124 is received.

The code-based search process 300 continues at operation 330, where the code 124 is analyzed to determine a search string to be input to the search engine 128. The analysis includes determining the context or subject matter of the code 124, e.g. what type of search it is or what type of good or service is requested to be searched. In the examples provided above in reference to FIG. 1, the code 124 comprising #Pizza is analyzed and determined to be a search for pizza restaurants.

The code-based search process 300 continues at operation 340, where the search string is generated. The presently disclosed subject matter is not limited to any particular type of search string. In an example given above in reference to FIG. 1, the search string included the type of search to be conducted (pizza restaurant) and the location of the mobile device 102 as a reference point to determine relevant search results.

The code-based search process 300 continues at operation 350, where the search string is transmitted to the search engine 128. As noted above, the search engine 128 can be of various configurations. For example, the search engine 128 can be an Internet-based search engine, whereby the search string is transmitted to the search engine 128 via an application programming interface (API). In other examples, the search engine 128 is a module of the carrier core network 112 that has access to one or more data stores having information stored therein relevant to the searches. The presently disclosed subject matter is not limited to any particular type of search engine 128.

The code-based search process 300 continues at operation 360, where search results are received from the search engine 128. In some examples, the search results can be modified using information from the search string. For example, the search string can include a filter that, when applied, limits the geographic area (such as a radius from a mobile device) to which search results should be applied. The search string can include other filters, or may include no filters. The presently disclosed subject matter is not limited to any particular configuration of filters.

The search results can be sorted in various manners, some of which are known to those of the ordinary skill in the art. For example, when using an Internet-based search engine, the search results may be presented as a listing from what the search engine determines to be the most relevant to the least relevant. Other examples of sorting the listing of search results can be used and are considered to be within the scope of the presently disclosed subject matter.

The code-based search process 300 continues at operation 370, where the IVR system is invoked. In some examples, the IVR system is used to present audible or textual results of the search process to the user. The IVR system can also be used to receive inputs from the user for more information relevant to a particular search result or a request for other information. The example in FIG. 2 illustrated the use of the IVR system to present visual aids for present search result choices and for receiving input from the user. The presently disclosed subject matter is not limited to any type of input. For example, the IVR system can present options such as ordering a pizza, reserving a table at a restaurant, or requesting a car rental pickup.

The code-based search process 300 continues at operation 380, where the search results are sent to the mobile device. Once the IVR system receives the search results, the IVR system presents the search results to the user. As noted above, the search results can be sent for rendering on the mobile device in various formats. For example, the search results can be translated to audio information using various text-to-voice technologies. In other examples, the search results can be presented using an interface, such as the interface described in FIG. 2.

The code-based search process 300 continues at operation 390, where input is received from the mobile device. The format of input can vary. For example, the input can be audio inputs received from the user of the mobile device. The inputs can also be keypad input or user interface input. The presently disclosed subject matter is not limited to any particular type of input. Once the input is received, the search service 122 can perform an action based on the input received. For example, the action can comprise various actions such as connecting the user to the selected service, connect to an interface of the selected service to perform the service requested by the user (such as order a car or reserve a table).

The IVR system input can be interactive. An input received from one prompt can initiate an additional presentation of input for the user to provide an input. For example, a user can be presented with several options (such as the options presented in FIG. 2). The mobile device can receive a selection of one of the options, which will cause the IVR system to issue a new set of options. Take for example restaurant reservations. The initial options may be the particular restaurant. A second set of options may be days or times in which a reservation may be made, and so forth.

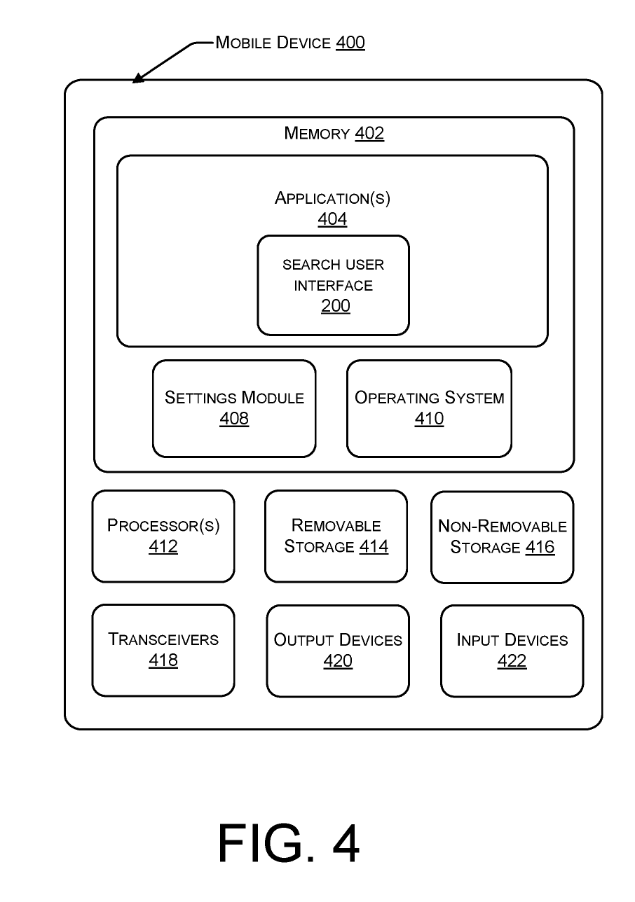

FIG. 4 illustrates a component level view of a mobile device 400 configured to function within a wireless communication network that may be used as the user mobile device 102. As illustrated, the mobile device 400 comprises a system memory 402 for storing application(s) 404. The applications 404 can include the search user interface 200. The mobile device 400 includes processor(s) 412, a removable storage 414, a non-removable storage 416, transceivers 418, output device(s) 420, and input device(s) 422. In various implementations, system memory 402 is volatile (such as RAM), non-volatile (such as ROM, flash memory, etc.) or some combination of the two. In some implementations, the processor(s) 412 is a central processing unit (CPU), a graphics processing unit (GPU), or both CPU and GPU, or any other sort of processing unit.

The mobile device 400 may also include additional data storage devices (removable and/or non-removable) such as, for example, magnetic disks, optical disks, or tape. Such additional data storage may include removable storage 414 and non-removable storage 416.

Non-transitory computer-readable media may include volatile and nonvolatile, removable and non-removable tangible, physical media implemented in technology for storage of information, such as computer readable instructions, data structures, program modules, or other data. System memory 402, removable storage 414 and non-removable storage 416 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the user device 400. Any such non-transitory computer-readable media may be part of the user device 400.

The non-transitory computer-readable media can be configured to store computer-executable instructions that, when executed by the processor 412, cause the processor 412 to perform the instructions.

In some implementations, the transceivers 418 include any sort of transceivers known in the art. For example, the transceivers 418 may include a radio transceiver that performs the function of transmitting and receiving radio frequency communications via an antenna. Also or instead, the transceivers 418 may include wireless modem(s) to may facilitate wireless connectivity with other computing devices. Further, the transceivers 418 may include wired communication components, such as an Ethernet port, for communicating with other networked devices.

In some implementations, the output devices 420 include any sort of output devices known in the art, such as a display (e.g., a liquid crystal display), speakers, a vibrating mechanism, or a tactile feedback mechanism. Output devices 420 also include ports for one or more peripheral devices, such as headphones, peripheral speakers, or a peripheral display.

In various implementations, input devices 422 include any sort of input devices known in the art. For example, input devices 422 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

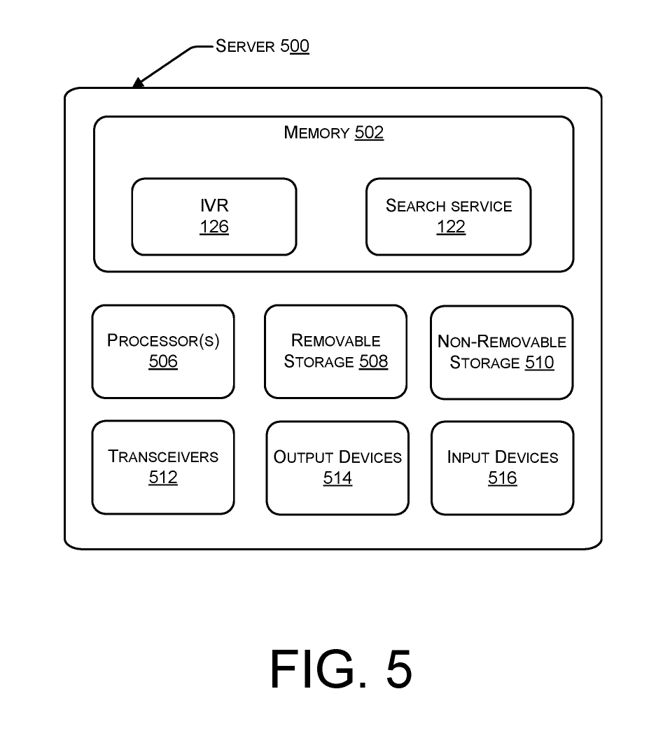

FIG. 5 illustrates a component level view of a server 500 configured for use within a wireless communication network in order to provide various services within the wireless communication network, such the IVR system 126 and the search service 122. The server 500 may be located in a radio network controller or gateway. Additionally, the server 500 may be a separate entity located separately from the RNC or gateway. As illustrated, the server 500 comprises a system memory 502 storing computer-executable instructions to implement the IVR system 126 and the search service 122. The system memory 502 may also store additional applications and programs. Also, the server 500 includes processor(s) 506, a removable storage 508, a non-removable storage 510, transceivers 512, output device(s) 514, and input device(s) 516.

In various implementations, system memory 502 is volatile (such as RAM), non-volatile (such as ROM, flash memory, etc.) or some combination of the two. In some implementations, the processor(s) 506 is a central processing unit (CPU), a graphics processing unit (GPU), or both CPU and GPU, or any other sort of processing unit.

The server 500 may also include additional data storage devices (removable and/or non-removable) such as, for example, magnetic disks, optical disks, or tape. Such additional storage is illustrated in FIG. 5 by removable storage 508 and non-removable storage 510.

Non-transitory computer-readable media may include volatile and nonvolatile, removable and non-removable tangible, physical media implemented in technology for storage of information, such as computer readable instructions, data structures, program modules, or other data. System memory 502, removable storage 508 and non-removable storage 510 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the server 500. Any such non-transitory computer-readable media may be part of the server 500.

In some implementations, the transceivers 512 include any sort of transceivers known in the art. For example, the transceivers 512 may include wired communication components, such as an Ethernet port, for communicating with other networked devices. Also or instead, the transceivers 512 may include wireless modem(s) to may facilitate wireless connectivity with other computing devices. Further, the transceivers 512 may include a radio transceiver that performs the function of transmitting and receiving radio frequency communications via an antenna.

In some implementations, the output devices 514 include any sort of output devices known in the art, such as a display (e.g., a liquid crystal display), speakers, a vibrating mechanism, or a tactile feedback mechanism. Output devices 514 also include ports for one or more peripheral devices, such as headphones, peripheral speakers, or a peripheral display.

In various implementations, input devices 516 include any sort of input devices known in the art. For example, input devices 516 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, the method comprising:
receiving a search code from a mobile device configured to invoke a code-based search service,
invoking the code-based search service,
determining a location of the mobile device,
analyzing the code and the location of the mobile device to determine a search string,
transmitting the search string to a search engine,
receiving search results from the search engine,
sending the search results to the mobile device using an interactive voice response system, and
receiving, via the interactive voice response system, an input related to the search results sent to the mobile device using the interactive voice response system.

2. The method of claim 1, further comprising wherein in response to receiving, via the interactive voice response system, the input related to the search results sent to the mobile device, sending a set of options based on the response.

3. The method of claim 1, wherein the code comprises a subject matter to be searched.

4. The method of claim 3, wherein the code comprises additional information to narrow a field of the search results.

5. The method of claim 1, further comprising communicatively connecting the mobile device over a cellular network with the search service upon receiving the code.

6. The method of claim 1, wherein the location of the mobile device comprises a latitude and longitude.

7. The method of claim 1, wherein the search results are sent to the mobile device as audible prompts.

8. The method of claim 1, wherein the search results are rendered on a graphical interface of the mobile device.

9. The method of claim 1, further comprising performing an action based on the input related to the search results.

10. A system, comprising:
a search service configured to:
receive a search code from a mobile device configured to invoke a code-based search service,
determine a location of the mobile device,
analyze the code and the location to determine a search string,
transmit the search string to a search engine,
receive search results from the search engine, and
communicate the search results to an interactive voice response system; and
the interactive voice response system configured to:
send the search results to the mobile device; and
receive an input related to the search results sent to the mobile device.

11. The system of claim 10, wherein the interactive voice response system is further configured to send a set of options to the mobile device based on the input related to the search results.

12. The system of claim 10, wherein the code comprises a subject matter to be searched.

13. The system of claim 12, wherein the code comprises additional information to narrow a field of the search results.

14. The system of claim 10, further comprising communicatively connecting the mobile device over a cellular network with the search service upon receiving the code.

15. The system of claim 10, wherein the location of the mobile device comprises a latitude and longitude.

16. The system of claim 10, wherein the search results are sent to the mobile device as audible prompts.

17. The system of claim 10, wherein the search results are rendered on a graphical interface of the mobile device.

18. The system of claim 10, wherein the search service is further configured to perform an action based on the input related to the search results.

19. An apparatus comprising:
a non-transitory storage medium; and
instructions stored in the non-transitory storage medium, the instructions being executable by the apparatus to:
communicatively connect to a carrier core network;
transmit a search code comprising a location of the apparatus to invoke a code-based search service of the carrier core network;
receive a communication from an interactive voice response system, the communication comprising search results from a search service;
transmit to the interactive voice response system an input related to the search results.

20. The apparatus of claim 19, wherein the instructions stored in the non-transitory storage medium further comprise instructions to render the search results on a graphical interface.
